(19) United States
(12) Patent Application Publication
(10) Pub. No.: US 2003/0134971 A1
(43) Pub. Date: Jul. 17, 2003

(54) Amino catalyst for polyurethane products

(76) Inventor: David H. Blount, San Diego, CA (US)

Correspondence Address: David H. Blount, 6728 Del Cerro Blvd., San Diego, CA, 92120, US

(21) Appl. No.: 10/361,177

(22) Filed: Feb. 10, 2003

Related U.S. Application Data
(63) Continuation-in-part of application No. 09/973,553, filed on Oct. 9, 2001.
Application No. 09/973,553 is a continuation-in-part of application No. 09/693,194, filed on Oct. 23, 2000, now Pat. No. 6,464,903.
Application No. 09/693,194 is a continuation-in-part of application No. 08/723,779, filed on Sep. 30, 1996, now Pat. No. 5,854,309.

(51) Int. Cl. C08K 3/00

(52) U.S. Cl. 524/589; 524/812

(57) ABSTRACT

Polyurethane products are produced by utilizing a urea and/or urea condensate and/or their salts of mineral acid or organic acids as the urethane catalyst and reacting an organic compounds with 1 or more active hydrogens with a polyisocyanates. The urea condensates which act as the urethane catalyst are produced by heating urea with itself or amino compounds or other active organic compounds or reacted with a mineral acid to form a salt. These urethane product may be produced in the form of solids, rigid foams, flexible foams, elastomers, adhesives and water based coating agents.

This application is a continuation-in-part of patent application Ser. No. 09/973,553 filed Oct. 9, 2001 which is a continuation-in-part of Ser. No.09/693,194, filed Oct. 23, 2002,which is a continuation-in-part of Ser. No.08/723,779 filled Aug. 30, 1996.

### FIELD

This invention concerns urea, urea condensates and their salts as novel urethane catalyst such as urea and urea reacted with itself or other organic compounds and their salts such as, urea condensates, partially hydrolyzed urea condensates, buiret, cyanuric acid, cyamelide, alkylurea, urea-organic compound condensates and their salts of organic and inorganic acids utilized as catalyst to promote the reaction of compounds containing active hydrogens and polyisocyanates, monoisocyanates with unsaturated radical or monoisocyanates to produce polyurethane products and polyisocyanurates. The polyurethane products, solid, semi-solid, flexible and rigid foams, adhesives, water based coating agents and other urethane products may be produced by the catalytic reaction of these urea compounds and urea condensate and their salts on polyisocyanates and compounds containing one or more active hydrogen.

### BACKGROUND

Urea compounds and their salts have been used as flame retardant for polyurethane but the use of urea and urea reacted with itself or other organic compounds and their salts as urethane catalyst is novel. The use of urea and derivative urea and their salt as urethane catalyst greatly reduces the cost of producing flame retarded polyurethane products. The urethane products produced using urea compounds, urea condensate and their salts as the urethane catalyst have many uses such as flame retarded flexible foams for cushing and packaging, semi-rigid and rigid foams for insulation and sound proofing, water based urethane for coating agent and adhesives and many other uses. Tertiary amines are the commonly used urethane catalyst along with organic metal catalyst.

What is lacking and what is needed are useful, safe and inexpensive urethane catalyst to take the place of corrosive and expensive amine urethane catalysts. What is additionally lacking are urethane catalyst that may also have attached water which can be used as the blowing agent for foamed polyurethane and also acts as a flame retardant compound in the polyurethane products.

### SUMMARY

Urea and urea, urea condensate and their salts such as urea, partially hydrolyzed urea condensate, urea condensates, biuret, cyanuric acid, cyamelide, urea-organic condensates and their salts of inorganic or organic acids, preferably having a pH above 6, maybe utilized as the urethane catalyst to produce urethane products. In one aspect of this invention comprises using urea, urea condensates and their salts as the urethane catalyst for producing urethane products. Another aspect of the invention is the production of urethane products. Another aspect of this invention is a process utilizing urea compounds, urea condensates or their salts as the urethane catalyst to produce polyurethane products which comprises contacting:

A) urea and/or urea condensate, and/or urea-organic compound condensate and/or their salts;

B) organic compound containing one or more active hydrogens;

C) polyisocyanate;

D) 0 to 20 parts by weight of a blowing agent, parts based on the weight of the component B;

E) 0 to 5 parts by weight of a surfactant, parts based on the weight of component B;

F) 0 to 20 parts by weight of a salt forming compound to adjust the pH;

G) 0 to 30 parts by weight of a carbonization auxiliaries parts based on the weight of Component B;

H) 0 to 10 parts by weight of urethane catalyst, parts based on weight of Component B;

I) 0 to 50 parts by weight of a filler, parts based on the weight of Component B.

Component A

Any suitable urea compounds and/or urea condensate and/or urea-organic compound condensate and/or their salts may be utilized. The urea compounds and/or urea condensate and/or their salts urethane catalysts are selected from the group consisting of urea, partially hydrolyzed urea condensate, urea condensate, biuret, cyanouric acid, cyamelide, alkylurea, urea-amino condensates such as urea-melamine condensate, urea-aminoguanidine condensate, urea-guanidine, urea-dicyandiamide, urea-organic compound condensates and their salts such as urea salts of organic phosphorus compounds such as phosphonates, phosphites, phosphorus esters and phosphates and mixtures thereof Urea is the preferred urethane catalyst. The urea compounds and their salt may be used in a powder form or in an aqueous or polyol solution or emulsion. The urea compounds and/or urea condensate and/or their salts urethane catalyst is utilized in the amount of 1 to 100 parts by weight based on the weight of Component B.

Any suitable nitrogen containing compound that will react with isocyanic acid and/or cyanic acid which is produced by heating urea may be utilized in this invention as urethane catalyst after they have reacted or condensate with urea. The nitrogen containing compound may be an organic or an inorganic compound. Suitable organic nitrogen containing compounds may be an aliphatic, aromatic, cyclic, aliphatic-aromatic or aliphatic-cyclic compound such as, but not limited to, urea, urea derivatives for example, O-alkylureas, amino compounds, for example, melamine, melamine cyanurate, dicyandiamide, biuret, guanidine, cyanoguanidine and aminoguanidine, ammonium carbonate, alkyl carbamates, alkyl isocyanates, polyisocyanates, sulfamic acid, ammonium sulfamate, amines, polyamines, thioureas, alkylanolamine, polyamides, amino hydrogen phosphates, amidines, amides, aldimines, ketimines, guanidine carbonate, amino carbonates, aminoborates, amino sulfates, thiourea, thiourea derivatives, compounds, such as amino phosphate, amino salts of organic phosphorus compounds and amino condensation salt of inorganic and organic phosphorus compounds. The urea condensation salt of phosphorus compounds are produced by contacting the urea condensation compounds with a phosphorus containing compound that will react with a urea compound, under conditions sufficient to prepare a urea condensation salt of a phosphorus containing compound. Suitable inorganic phosphorus compounds that will react with urea include, but not limited to, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, mono-metal hydrogen phosphates, ammonia dihydrogen phosphate, bromated phosphates, alkali metal dihydrogen phosphate and halogenated phosphate-phosphite and their halides and acids. organic phosphorus compounds that will react with urea compounds and condensate include, but not limited to, alkyl, cyclic, aryl and alkyl-aryl phosphorus compounds, such as, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, aryl hydrogen phosphates, halogenated phosphonates esters and mixtures thereof. Urea condensation borates may be produced by contacting boric acid and urea condensation compound under conditions sufficient to prepare the urea condensation borates which may also be utilized as a flame-retardant compound. Urea condensation boron-phosphates may be produced by contacting boron-phosphates and amino condensation compounds under conditions sufficient to prepare urea condensation boron-phosphate compounds which may also be utilized as a flame-retardant compound. The salt forming phosphorus containing compounds will react with the urea condensation compounds to form a urea condensation salt of a phosphorus containing compound. Suitable inorganic nitrogen containing compounds will react or condensate with urea such as, but not limited to, ammonium phosphate, diammonium phosphate, ammonium polyphosphate, ammonia borate, ammonium hydrogen sulfate, quaternary ammonium salts, ammonium bicarbonate, ammonium carbonate, etc. and mixtures thereof.

Any suitable reactive organic compound that will react with isocyanic acid and/or cyanic acid, which is produced by heating urea, may be utilized in this invention as urethane catalyst after it has reacted or formed a condensation with urea . Suitable organic saturated, unsaturated or substituted compounds may be an aliphatic, aromatic, cyclic, aliphatic-aromatic or aliphatic-cyclic compound such as, but not limited to, alcohols, polyalcohols, epoxides, polyepoxides, epihalohydrins, organic acids, polycarboxylic acids and hydrides, thioalcohols, phenols, thiophenols, halogenated alcohols and polyalcohols, halogenated organic compounds, halogenated organic acids and polycarboxylic acids, sulphonic acid chlorides, organic ester, organic ethers, thioethers, ketones, nitriles, sulphonic acids, imides, alkyl carbonates, oils, fats, carbohydrates, cellulose, lignin, wood flour, acrylic acid, alkyl acrylic acids, allyl alcohol, allyl chloride, polyvinyl alcohol, organic phosphates, phosphites, phosphonates and phosphorus esters, alkyl chlorophosphines, phosgene, ammonium carbonate, alkyl carbamates, alkyl isocyanates, polyisocyanates, sulfamic acid, ammonium sulfamate, amino compounds, amines, polyamines,, thioureas, alkylanolamine, polyamides with free —NH or —COOH radicals, amidines, amides, aldimines, ketimines, polyester with free —OH or COOH radicals and mixtures thereof,

The organic compound may contain one or more of the following radicals:

—Cl, —Br, —F, —OH, —COOH, —CN, —NO , —COCl, —COBr. —NCO, —C═C—, —NH,

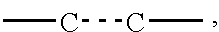

—O—P—O—, —O—P—O—

O O— O

—SO OH, —SH, —SiCl and mixtures thereof.

Suitable epoxy compounds include but not limited to alkyl epoxide such as ethylene oxide, propylene oxide, butylene oxides, trichlorobutylene oxide, epihalohydrins, 2,3-epoxybutane, 1,2-epoxydecane, 1,2,-epoxyactadecane; unsaturated ether, epoxide such as ally glycedyl ether; dialkylatable epoxides such as tert-butyl glycidyl ether; and other polyepoxides and mixtures thereof. The epihalohydrins are preferred.

Any suitable alcohol or polyalcohols may be chemically reacted or form condensation with urea, suitable alcohols include, but are not limited to, aliphatic alcohols such as methanol, ethanol, sec-butanol, 1-buten-4-ol and propargyl alcohol and substituted alcohols such as 2-fluoroethanol, 2-chloroethanol, 2-bromoethanol, 2-cyanoethanol; aromatic alcohols such as phenol and benzyl alcohols and mixtures thereof. Alkyl alcohols are preferred.

Suitable polyalcohols include, but are not limited to, diols such as ethylene glycol, propylene, glycol butylene glycol, polyethylene glycol, polypropylene glycol, polybutylene glycol, triols such as 1,2,-propanetriol, 1,2,3-butanetriol, 1,2,10-decanetriol, 2,2-bis(hydroxymethyl)-1-octanol and 2-methyl-2-(2-hydroxyethoxy)-1-1,3-propanediol, sucrose, sucrose amine polyols, polypropylene polyols, polybutylene polyols, phenyl polyols, phenylamine polyols, polyether polyols, polyepichlorohydrin, polyepibromohydrin, sorbitol, pentaerythritol, polythioether polyols, polyacetal polyols, polycarbonate polyols, polyester polyols, polyesteramide, polyamide polyol, modified or unmodified natural polyols, carbohydrates, cellulose and mixtures thereof. The polyols may contain halo, cyano, ether, thioether, sulfoxy and ocyl ester radicals.

Component B

Any suitable compound containing one or more active hydrogens may be utilized as component B. It is preferred that the compound is an organic compound containing two or more active hydrogens such as polyalcohols, fatty acids, proteins, caster oil, starches, phenols, thiophenols, aldehydes, lignin, phenol formaldehyde resins, urea formaldehyde resins, polyepoxy compounds, polyamines, alcoholamines, amino compounds, polyesters, polyethers, polythioethers, polyacetals, polycarbonates, polyesterarides, organic polycarboxylic acids or anhydrides, carbohydrates, water and mixtures thereof. The dihydric, trihydric and polyhydric alcohols are preferred.

The compound containing 1 or more active hydrogens may be used in the amount of 50 to 200 parts by weight.

Component C

Any suitable isocyanate may be used in this invention. Organic polyisocyanates are preferred. The commercial available ones are preferred such as tolylene-2,4-diisocyanate, tolylene-2,6-diisocyanate, polymethylene polyphenyl isocyanate, diphenymethane-4,4′-dilsocyanate, 3-methlydiphenyl-methane-4,4′-diisocyanate, m- and p-phenylenedisocyanante, polyphenylmethylene isocyanate obtaine by phosgenation, commerically known as “crude MDI” modified polyisocyanates and mixtures thereof. Suitable organic polyisocyanates are exemplified by the organic dilsocyanates which are compounds of the general formula:

O═C═N—R—N═C═O

wherein R is a divalent organic radical such as an alkylene, aralkylene or arylene readicas, such radicals may contain 2 to 20 carbon atoms. The polyisocyanates are well know in the Arts. The polyisocyanates may be utilized in the amount of 50 to 200 parts by weight based on the weight of component B.

Component D

Any suitable blowing agent may be utilized. Water may be use as a blowing agent. It may be attached to amino catalyst or added to the urea catalyst to for an emulsion or solution. Any suitable organic blowing agent maybe utilized. The blowing agent is utilized in the amount of 0 to 20 parts by weight based on the weight of component B.

Component E

Any suitable surfactant that will stabilize the cell formation in the production of urethane products or is a emulsifier may be used in this invention. The water soluble polyester siloxanes are preferred. The surfactant may be utilized in the amount of 0 to 5 parts by weight based on the weight of component B. Any suitable surfactant that will assist in the production of foamed cells or used as a wetting agent may be used in this invention, such as soaps, detergents and silicon surfactant, such as water-soluble polyester siloxane. Any surface active agent that will assist in the formation of foam or as a wetting agent such as cationic, anionic, non-ionic and amphoteric surfactant may be used in this invention. The surfactant is not a necessary component except when foam cells and wetting agents are desired.

Component F

Any suitable basic salt forming compound containing an alkali metal or alkaline metal oxide or hydroxide may be used in this invention to adjust the pH of the urea type urethane catalyst. Alkali metal oxides or hydroxide and alkaline earth metal oxides and hydroxide, preferable sodium hydroxide and zinc oxide. The basic salt forming compound such as sodium hydroxide or zinc oxide may be first reacted with the boron oxyacid to produce sodium borate or zinc borate. Alkali metal or alkaline earth metal borates may be utilized in the production of urethane foams to prevent termites infestation or to adjust the pH of the urea type urethane catalyst. Basic nitrogen containing salt forming compounds may also be used to adjust the pH such as ammonia, amines and amino compounds.

Any suitable acidic salt forming compounds such as mineral acids and organic acids may be used to adjust the pH of the urea type urethane catalyst. The salt forming compound may be use in the amount of 0 to 20 parts by weight based on the weight of Component B.

Component G

Any suitable carbonization auxiliaries may be utilized in this invention. Suitable carbonization auxiliaries are compounds that in the presence of fire assist the formation of a carbonization foam or char, such as, additives that produce acidic components in the pyrolysis mixture, such as phosphorus acids, boric acids or sulfuric acids. These acidic components are compounds such, for example, acids or salts, or their derivatives of sulfur, boron and phosphorus, such as, boron-phosphates, phosphates, and polyphosphates of ammonia, amines, polyamines, amino compounds, thioureas and alkyanolamines, but boric acid and its salts and their derivatives, organic phosphorus compounds and their salts, halogenated organic phosphorus compounds, their salts and their derivatives, sulfuric acids, their salts and their derivatives such as ammonium sulfate, urea sulfate, etc., may also be used for this purpose. The commonly known fertilizer which contains phosphorus or sulfur are inexpensive carbonization auxiliaries that can be used with the aqueous urea. The carbonization auxiliaries and other flame retardant agents may be used in quantities of 0 to 200 parts by weight. The carbonization auxiliaries and other flame retardant agents are not a necessary component but when used is used in an amount of 0 to 30 part by weight based on the weight of Component B.

The nitrogen containing salts of phosphorus acids are the preferred carbonization compounds, such as amino phosphate, amine and polyamine phosphates, amino salts of organic phosphorus compounds and amino condensation salt of inorganic and organic phosphorus compounds. The condensation salt of phosphorus compounds are produced by contacting urea condensates such as, biuret, cyanuric acid and cyamelide or other amino compounds with a phosphorus containing compound that will react with an amino compound, under conditions sufficient to prepare an amino salts of a phosphorus containing compound. Suitable inorganic phosphorus compounds include, but not limited to, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, and their salts, amino phosphates, amine phosphates, mono-metal hydrogen phosphates, ammonium dihydrogen phosphate, ammonium phosphate, bromated phosphates, alkali metal dihydrogen phosphate, and halogenated phosphate-phosphite and their halides and acids. organic phosphorus compounds include, but not limited to, alkyl, cyclic, aryl and alkyl-aryl phosphorus compounds, such as, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, aryl hydrogen phosphates, halogenated phosphonates esters, biuret phosphate, cyanuric phosphate, cyamelide phosphate, and urea, biuret, cyanuric acid and cyamelide borates and mixtures thereof.

Component H

Urethane catalyst may also be utilized with the urea type urethane catalyst such as suitable organic metal urethane catalyst and suitable urethane tertiary amine catalyst and other urethane catalyst may be used in the amount of 0 to 10 parts by weight based on the weight of component B.

Component I

Any suitable filler may be used in this invention. The fillers that may be utilized in the flame retardant mixture are usually insoluble in the reaction mixtures. They may be inorganic substances, such as, alkali metal silicates, alkaline earth metal silicates, metal silicates, silica, metals, oxides, carbonates, sulphates, phosphates, borates, glass beads or hollow glass beads. Hydrated aluminum oxide is preferred. They may be organic substances, such as, amino compounds, such as urea, melamine, dicyandiamide, urea condensates, urea-amino condensates, partially hydrolyzed urea condensates and other amino derivatives or their formaldehyde resins, amino phosphates, amino salts of organic phosphates, phenol-aldehyde resin powder, ammonium sulfates, urea sulfates, nitrogen containing sulfates, powdered coke, graphite, graphite compounds, Portland cement, lignin and mixtures thereof. The organic halide flame retardant compounds may also be added as fillers. The filler may be used in the amount of 0 to 200 weight. Fillers are not a necessary component, but useful, and if used it is used in the amount of 0 to 50 parts by weight.

Any suitable metal-containing compound that will accelerate carbonization effect used in this invention increases the amount of carbonization residue after combustion, thereby enhancing the flame retardant effect and may be used in this invention. These compounds include, but not limited to, alkaline earth metal borates such as magnesium borate, calcium magnesium borate and the like, manganese borate, zinc borate, metal oxides of titanium oxide, tin oxide, nickel oxide, zinc oxide and the like, ferrocene, dimethylglyoxime copper, acetyl-acetonatocooper, hydroxyquinoline nickel and the like, zinc thiocarbamate compounds such as zinc dimethylthio-carbamate, zinc di-n-butyldithiocarbamate and the like, mercaptobenzothiazole zinc compounds such as mercaptobenzothiazole zinc and the like, salicyadehyde zinc compounds such as salicylaldehyde zinc and the like, metal hydroxides such as aluminum hydroxide, magnesium hydroxide, calcium magnesium hydroxide, zirconium hydroxide and the like and mixtures thereof. The most preferable compounds are selected from zinc oxide, zinc thiocarbamates, the mercaptobenzothiazole zinc compounds the salicyaldehyde zinc compounds, zinc borate and the alkaline earth metal borates. The are utilized in the amount of 0 to 30 parts by weight. These metal containing carbonization accelerators are not necessary components but when used it is used in the amount of 0 to 30 parts by weight.

Optional components include, water, initiator, filler, diluents, activators, coloring, stabilizers, modifying compounds, plasterizers, dyes, negative catalyst, pigments, stabilizers against aging and weathering, fungicidal and bacteriocidal substances, etc. maybe used in this invention.

Any suitable metal-containing compound that will accelerate carbonization effect used in this invention increases the amount of carbonization residue after combustion, thereby enhancing the flame retardant effect and may be used in this invention. These compounds include, but not limited to, alkaline earth metal borates such as magnesium borate, calcium magnesium borate and the like, manganese borate, zinc borate, metal oxides of titanium oxide, tin oxide, nickel oxide, zinc oxide and the like, ferrocene, dimethylglyoxime copper, acetyl-acetonatocooper, hydroxyquinoline nickel and the like, zinc thiocarbamate compounds such as zinc dimethylthio-carbamate, zinc di-n-butyidithiocarbamate and the like, mercaptobenzothiazole zinc compounds such as mercaptobenzothiazole zinc and the like, salicyadehyde zinc compounds such as salicylaldehyde zinc and the like, metal hydroxides such as aluminum hydroxide, magnesium hydroxide, calcium magnesium hydroxide, zirconium hydroxide and the like and mixtures thereof. The most preferable compounds are selected from zinc oxide, zinc thiocarbamates, the mercaptobenzothiazole zinc compounds the salicyaldehyde zinc compounds, zinc borate and the alkaline earth metal borates. The are utilized in the amount of 0 to 30 parts by weight. These metal containing carbonization accelerators are not necessary components but when used it is used in the amount of 0 to 30 parts by weight.

Any suitable metal-containing compound that will accelerate carbonization effect used in this invention increases the amount of carbonization residue after combustion, thereby enhancing the flame retardant effect and may be used in this invention. These compounds include, but not limited to, alkaline earth metal borates such as magnesium borate, calcium magnesium borate and the like, manganese borate, zinc borate, metal oxides of titanium oxide, tin oxide, nickel oxide, zinc oxide and the like, ferrocene, dimethylglyoxime copper, acetyl-acetonatocooper, hydroxyquinoline nickel and the like, zinc thiocarbamate compounds such as zinc dimethylthio-carbamate, zinc di-n-butyidithiocarbamate and the like, mercaptobenzothiazole zinc compounds such as mercaptobenzothiazole zinc and the like, salicyadehyde zinc compounds such as salicylaldehyde zinc and the like, metal hydroxides such as aluminum hydroxide, magnesium hydroxide, calcium magnesium hydroxide, zirconium hydroxide and the like and mixtures thereof. The most preferable compounds are selected from zinc oxide, zinc thiocarbamates, the mercaptobenzothiazole zinc compounds the salicyaldehyde zinc compounds, zinc borate and the alkaline earth metal borates. The are utilized in the amount of 0 to 30 parts by weight.

Any suitable compound that will reflect heat compound such as titanium oxide may be used in this invention and used in the amount of 0 to 30 part by weight.

### DESCRIPTION OF PREFERRED EMBODIMENTS

My invention will be illustrated in greater detail by the specific examples which follows, it being understood that theses preferred embodiments are illustrative of, but not limited to, procedures which may be used in the production of flame retarded polyurethane products by utilizing amino compounds and the urethane catalyst. Parts and percentages are by weight unless otherwise indicated.

### EXAMPLE 1

15 parts by weight of poly(oxyalkylene) triol, mol. Wt. 3,500, hydroxyl No. 57 and 5 parts by weight of urea powder are mixed, then 8 parts by weight of Tolylene diisocyanate (MONDUR TDI) is added and mixed. The mixture cures to form a tough flexible solid polyurethane product.

### EXAMPLE 2

Example 1 is modified wherein another urea-organic compound condensate and/or its salts is used in place of urea in the amount of 1 part by weight and selected from the group below:

| | | | |
|---|---|---|---|
| a) | biuret | b) | cyanuric acid |
| c) | urea condensate | d) | hydrolyzed urea condensate |
| e) | methyl urea | f) | diurea phosphate |
| g) | urea borate | h) | biuret phophate |
| i) | urea condensate salt of | j) | cyanuric acid phosphate |
| | phosphoric acid | | |
| k) | urea sulfate | l) | urea-melamine condensate |
| m) | urea acetate | n) | urea condensate salt of acetic acid |
| o) | urea salt of dimethylmethyl | p) | urea salt of dimethyl hydrogen |
| | phosphonate | | phosphite |
| q) | urea-melamine condensate | r) | urea-propanol condensate. |

### EXAMPLE 3

15 parts by weight of poly(oxyalkylene) triol, mol. wt. 3,500, hydroxyl No. 57, 0.2 parts by weight of DOW 190 surfactant and 4 parts by weight of urea powder are mixed then 10 parts by weight of polymeric polyisocyanate (PMDI) is added and mixed. The mixture slowly expanded a small amount and is cured into a tough micro-cellular flexible solid.

### EXAMPLE 4

Example 1 is modified wherein 12 parts by weight of MDI is used in place of the TDI.

### EXAMPLE 5

5 parts by weight of urea powder is mixed with 1 part by weight of water then mixed with 15 parts by weight of polypropylene triol, mol. wt. 3,000, hydroxyl No. 42 then 0.2 parts by weight of DOW 190 surfactant and 8 parts by weight of TDI (MONDUR TDI) are added then mixed. The mixture expands in 20 seconds to produce a flame retarded flexible polyurethane foam of about 2 lbs./cu.ft.

### EXAMPLE 6

Example 5 is modified wherein 10 parts by weight MDI is used in place of the TDI.

### EXAMPLE 7

Example 5 is modified wherein another urea condensate or urea reacted with another organic compound is used in place of urea in the amount of 2 parts by weight and selected from the list below:

| | | | |
|---|---|---|---|
| a) | polyurea phosphate | b) | urea-ethyldiamine condensate |
| c) | urea condensate salt of | d) | urea condensate salt of acetic acid |
| | boric acid | | |
| e) | biuret | f) | cyanuric acid and cyamelide |
| g) | urea nitrate | h) | hydrolyzed urea condensate |
| i) | urea-melamine condensate | j) | urea condensate |
| k) | urea salt of adipic acid | l) | urea salt of dimethyl methyl |
| | | | phosphonate |
| m) | urea-guanidine condensate | n) | urea condensate salt of |
| | | | phosphorous acid |
| o) | urea salt of cyclic | p) | urea salt of diethy ethyl |
| | phosphonate | | phosphonate |
| q) | urea condensate salt of | r) | urea salt of acrylic acid |
| | boron-phosphate | | |

### EXAMPLE 8

Example 5 is modified wherein MDI is used in place of TDI.

### EXAMPLE 9

5 parts by weight of urea is mixed with 2 parts by weight of water then added to 15 parts by weight of polypropylene triol, mol. wt. 3,000, hydroxyl No. 56. DOW 190 surfactant in the amount of 0.2 parts by weight is add to the mixture, then 8 parts by weight of TDI is added and mixed. The mixture expand in about 20 seconds to produce a 1.5 lbs/cu.ft. flame retarded flexible foam.

### EXAMPLE 10

5 parts by weight of urea is mixed with 2 parts by weight of water then added to 15 parts by weight of poly(oxyalklene) triol with 0.2 parts by weight of DOW 190 surfactant then 12 parts by weight of MDI is added and mixed. The mixture expands in about 20 seconds and is cured in about 30 seconds to form a 2 lbs./cu.ft. flame retarded flexible foam.

### EXAMPLE 11

Example 5 is modified wherein a organic tin catalyst, (DABCO T9) in the amount of 0.01 parts by weight is added to the poly(oxyalklene) triol.

### EXAMPLE 12

Example 10 is modified wherein an tertiary amine catalyst, (POLYCAT 33 lv) in the amount of 0.05 parts by weight is added to the polypropylene triol.

### EXAMPLE 13

Example 10 is modified wherein another urea type urethane catalyst is added in place of urea in the amount of 3 parts by weight and selected from the list below:

a) partially hydrolyzed condensated urea
b) biuret
c) cyanouric acid and cyamelide mixture
d) urea condensate
e) partially hydrolyzed salt of phosphoric acid
f) buiret phosphate
g) cyanouric acid salt of phosphoric acid
h) urea condensate salt of phosphoric acid

### EXAMPLE 14

5 parts by weight of urea powder with attached water, 0.01 parts by weight of surfactant (DOW 193), and 15 parts by weight of polypropylene polyol, viscosity 550, hydroxyl No. 380, are mixed the 15 parts by weight of PMDI (MONDUR MR FROM BAYER) are mixed. The mixture expands and is cured in about 3 minutes to produce a 4 lbs./cu.ft. flame retarded, rigid polyurethane foam.

### EXAMPLE 15

Example 14 is modified wherein another polyol is used in place of polypropylene polyol and selected from the list below:

| | | | |
|---|---|---|---|
| a) | sucrose amine polyol hydroxyl | b) | polyether polyol (VORANOL |
| | No. 357 | | SF 265) |
| c) | polyether polyol (VORANOL | d) | Multranol 4030 (Bayer) |
| | 335-DOW) | | |

### EXAMPLE 16

Example 14 is modified wherein the 5 parts by weight of urea is mixed with 1 part by weight of water thereby producing a rigid polyurethane foam of about 2 lbs./cu.ft.

### EXAMPLE 17

Example 14 is modified wherein a carbonization auxiliary is added to the polyol in the amount of 5% by weight, percentage based on the weight of the polyol and selected from the list below:

a) dimelamine phosphate
b) dicyandiamide phosphate
c) urea dihydrogen phosphate
d) guanidine phosphate
e) aminoguanidine phosphate
f) diethyltriamine urea phosphate
g) melamine salt of dimethyl methyl phosphonate
h) melamine salt of dimethyl hydrogen phosphite
i) methylamine melamine phosphoric acid
j) methyl carbamate salt of phosphoric acid
k) melamine salt of boron-hydrogen phosphate
l) O-methyl urea borate
m) urea salt of boron-phosphate
n) urea-formaldehyde phosphate
o) aminophenol phosphate
p) ammonium urea phosphate
q) ammonium melamine phosphate
r) melamine salt of trimethyl phosphite
s) melamine salt of phenyl acid phosphate
t) cyanuric phosphate

### EXAMPLE 18

About 25 parts by weight of aqueous emulsion containing 20% urea, 20 % sucrose, 2% amine urethane catalyst and 0.3% silicone foam regulator surfactant are mixed with 35 parts by weight of MDI thereby producing a rigid, fine cells, polyurethane foam which weighed about 1 lb./cu. ft. After 1 week a ½″×2″×6″ vertically placed sample of this foam was tested using a 2″ blue Bunsen burner flame placed at the bottom of the sample for 1 minute. The foam under the flame formed a char. The foam did not catch on fire.

### EXAMPLE 20

Example 18 is modified wherein 10% by weight, based on the weight of the aqueous emulsion, of a filler selected from the list below is added to the aqueous urea condensate composition and selected from the list below:

a) hydrated aluminum oxide powder
b) hydrated sodium silicate powder
c) melamine
d) dicyandiamide
e) urea sulfate
f) melamine phosphate
g) melamine borate
h) ammonium phosphate
i) ammonium pyrophosphate
j) ammonium carbonate
k) ammonium borate
l) ammonium sulfamate
m) guanidine
n) guanidine carbonate
o) urea phosphate
p) silica powder
q) phenol-formaldehyde resin powder
r) aluminum phosphate
s) thiourea
t) hollow beads
u) expandable graphite
v) melamine salt of DMMP
r) ammonium sulfate
s) magnesium chloride
t) antimony trioxide
u) boron-phosphate powder
w) melamine boron-phosphate powder

### EXAMPLE 21

About 25 parts by weight of an aqueous emulsion which contains 50% by weight of the urea condensate-boron oxyacid salt and 10 parts by weight of dimethyl hydrogen phosphite, 100 parts by weight of triol component (Daloflex XES 11870 by ICI of Europe) and 60 parts by weight of diphenymethane-4,4′-diisocyanate were mixed and expanded with in 40 seconds into a flexible foam of about 1.5 lbs./cu. ft. After the foam cured for 1 week it was flame tested using Calif. TB 133. The foam sample passed this test with a 44 gms weight loss. Europe's UL94 HF-1, HF-2 flame test were done using a 2 cm flame from a propane torch for 1 minute placed under the ½″×2″×6″ sample. This foam passed the test. The sample did not catch on fire and the melted drips did not catch on fire.

### EXAMPLE 22

75 parts by weight urea-aminoguanidine condensate, 200 parts by weight of sucrose amine polyol, hydroxyl No. 350, 10 parts by weight of ammonium urea phosphate, 0.05 parts by weight of tin catalyst (Dabco T-12 by Air Products) and 280 parts by weight of Diphenymethane-4,4′-diisocyanate are mixed then poured into a mold. A rigid foam of about 1.5 lbs./cu. ft. is formed. After 1 week this foam is flame tested with a 2″ propane flame by placing the flame at the bottom of a ½″×2″×6″ sample for 1 minute. The flame did not spread and the flame went out when the flame was removed. A char was formed and there was about a 4% weight loss.

### EXAMPLE 23

Example 22 is modified wherein another polyol is used in place of the sucrose amine polyol and selected from the list below:

a) sucrose amine polyol, hydroxyl No. 530 with 25% polypropylene polyol, hydroxyl No. 450;

b) aromatic amino polyol, hydroxyl No. 530 with 25% polypropylene polyol, hydroxyl No. 650;

c) aromatic polyester polyol, hydroxyl No. 350;

d) sucrose polyol, hydroxyl No. 450;

e) phosphorus polyol (VIRCOL 82 by Albright and Wilson).

These samples were tested as above with same good results.

### EXAMPLE 24

Example 22 is modified wherein another polyisocyanate is used and selected from the list below:

a) polymeric MDI (Mondur MR by Miles)

b) polymeric MDI ( PAPI 27 by Dow)

c) polymeric MDI (Mondur MRS).

### EXAMPLE 25

100 parts by weight of ethylene modified polypropylene glycol (Multranol 7056 by BAYER), 20 parts by weight of the urea powder, 10 parts by weight of melamine phosphate,1 part by weight of silicone surfactant (L6202 by Union Carbide), and 50 parts by weight of TDI (Mondur TD80) are mixed then poured into a mold. The mixture began to expand in 20 seconds and is fully expanded in 40 seconds. A flame retardant flexible foam of about 1.5 lbs./cu.ft. is produced. The foam was cured for 1 week then flame tested with a 2″ propane flame placed under a ½″×2″×6″ sample (UL94-1,HF-2 TEST). The flame did not spread and the melted drippings did not burn.

### EXAMPLE 26

Example 25 is modified wherein another carbonization agent is added to in place of melamine phosphate and selected from the list below:

a) diaminophosphate
b) dimethyl methyl phosphonate
c) urea phosphate
d) melamine borate
e) ammonium melamine boron phosphate
f) diethyl phosphite
g) ammonium polyphosphate
h) dicyandimide phosphate
i) ammonium phosphate
j) aluminum phosphate
k) tris2-chloroethyl phosphite
l) zinc borate
m) boron oxide
n) boric acid
o) dimethyl phosphite
p) triethy phosphate
q) guanidine phosphate
r) ammonium sulfamate
These examples were tested as in Example 25 and passed this test.

### EXAMPLE 27

100 parts by weight of ethylene modified polypropylene glycol (Multranol 7056 by Miles), 10 parts by weight of urea condensate-phosphorus oxyacid salt, 10 parts by weigh urea powder, 20 parts by weight of melamine phosphate,1 part by weight of silicone surfactant (L6202 by Union Carbide), and 50 parts by weight of TDI (Mondur TD80) are mixed then poured into a mold. The mixture begins to expand in 12 seconds and fully expands in about 30 seconds. A flame retardant flexible foam of about 1.5 lbs./cu.ft. is produced. The foam was cured for 1 week then flame tested with a 2″ propane flame placed under a ½″×2″×6″ sample and was rated(UL94-1,HF-2).

Others modifications of my invention will occur to those skilled in the Art upon reading my disclosure. These are intended to be included within the scope of my invention, as defined in the appended claims.

I claim:

1. The polyurethane products produced by utilizing a urea and/or a urea condensate compounds and/or their salts as the urethane catalyst to produce polyurethane products by mixing and reacting the following components:
A. urea and/or a urea condensate and/or urea-organic compound condensate and/or their salts as the urethane catalyst;
B) compound containing one or more active hydrogens that will react with isocyanate radicals;
C) polyisocyanate
D) blowing agent, in the amount of 0 to 30 parts by weight based on weight of component B;
E) surfactant in the amount of 0 to 10 parts by weight based on the weight of component B;
F) salt forming compound, 0 to 10 parts by weight based on the weight of Component B;
G) carbonization auxiliaries, 0 to 30 parts by weight based on the by weight of Component B;
H) urethane catalyst, in the amount of 0 to 10 parts by weight based on the weight of component B;
I) filler, 0 to 100 parts by weight based on weight of component B;

2. The polyurethane product of claim 1 wherein the urea and/or urea condensate and/or their salts urethane catalyst is selected from the group consisting of urea, urea salt of mineral acid, partially hydrolyzed urea condensate, partially hydrolyzed urea condensate salt of mineral acid, biuret, biuret salt of mineral acid, cyanouric acid, cyanuric acid salt of mineral acid, urea-amino condensate, urea-amino condensate salt of mineral acids, urea-organic compound condensates, urea-organic compound condensates salts of mineral acids, alkylurea, alkylurea salt of mineral acids and mixtures thereof.

3. The polyurethane product of claim I wherein the urea and/or urea condensate and/or their salts as the urethane catalyst is urea.

4. The process for producing polyurethane products by using urea and/or a urea condensate and/or their salts as the urethane catalyst to produce polyurethane products by mixing and reacting the following components:
A) urea and/or urea condensate and/or urea-organic condensate and/or their salts as the urethane catalyst, 1 to 100 parts by weight;
B) compound containing one or more active hydrogens that will react with isocyanate radicals, in the amount of 50 to 200 parts by weight;
C) polyisocyanate, in the amount of 50 to 200 parts by weight;
D blowing agent, in the amount of 0 to 30 parts by weight;
E) surfactant in the amount of 0 to 10 parts by weight;
F) salt forming compound, 0 to 10 parts by weight;
G) carbonization auxiliaries, 0 to 30 parts by weight;
H) urethane catalyst, in the amount of 0 to 10 parts by weight;
I) filler, 0 to 100 parts by weight;

5. The process of claim 4 for producing polyurethane products produced by using a urea and/or urea condensate and/or their salts as the urethane catalyst wherein the urethane catalyst is urea.

6. The process of claim 4 for producing polyurethane products produced by using urea and/or urea condensate and/or salts as urethane catalyst consist of mixing and reacting the following components:
1) urea as the urethane catalyst, in the amount of 100 to 200 parts by weight;
2) polyol, in the amount of 50 to 200 parts by weight;
3) water, in the amount of 0 to 30 parts by weight;
4) surfactant, in the amount 0 to 10 parts by weight;
5) blowing agent, in the amount of 0 to 10 parts by weight;

7. The urethane catalyst selected from the group consisting of urea compound and/or urea condensate and/or urea-organic compound condensate and/or their salts.

8. The urethane catalyst of claim 7 wherein the urethane catalyst is a urea salt selected from the group consisting of urea phosphate, urea borate, urea salt of organic phosphonate, urea salt of organic phosphite, urea salt of organic phosphate, urea salt of organic phosphorus esters, urea salt of boron-phosphate, alkylurea phosphate, urea sulfate and mixtures thereof.

9. The urethane catalyst of claim 7 wherein the urethane catalyst is a urea condensate selected from the group consisting of urea condensate, partially hydrolyzed urea condensate, urea condensate salt of phosphorus oxyacid, urea condensate salt of organic phosphonates, urea salt of organic phosphites, urea condensate salt of organic phosphates, urea condensate salt of organic phosphorus esters and mixtures of the above.

10. The urethane catalyst of claim 7 wherein the urethane catalyst is a urea-organic compound or condensate selected from the group consisting of urea-melamine condensate, urea-melamine condensate salt of phosphorus oxyacid, urea-melamine salt of organic phosphonate, urea-dicyandimide consensate, urea-dicyandimide condensate salt of phosphorus oxyacid, urea-melanilne salt of organic phosphonate, urea-aminoguanidine condensate, urea-aminoguanidine salt of phosphorus oxyacid, urea-aminoguanidine salt of organic phosphonate, urea acetate, urea propanate, urea salt of acrylic acid, urea condensate of acetic acid, urea salt of malic acid and mixtures thereof.

11. The product produced by the process of claim 4.

12. The polyurethane product of claim 1 produced by utilizing a urea and/or urea condensate and/or their salts as the urethane catalyst is a partially hydrolyzed urea condensate.

13. The polyurethane product of claim 1 produced by utilizing a urea and/or urea condensate and/or their salts as the urethane catalyst is a urea salt of a phosphorus oxyacid.

14. The polyurethane product of claim 1 produced by utilizing a urea and/or urea condensate and/or their salts as the urethane catalyst is a urea salt of an organic phosphorus compound.

15. The polyurethane product of claim 1 produced by utilizing a urea and/or urea condensate and/or their salts as the urethane catalyst is alkyl urea.

16. The polyurethane product of claim 1 produced by utilizing a urea and/or urea condensate and/or their salts as the urethane catalyst is buiret.

17. The polyurethane product of claim 1 produced by utilizing a urea and/or urea condensate and/or their salts as the urethane catalyst is cyanuric acid.

18. The polyurethane product of claim 1 produced by utilizing a urea and/or urea condensate and/or their salts as the urethane catalyst is urea acetate.

19. The polyurethane product of claim I produced by utilizing a urea and/or urea condensate and/or their salts as the urethane catalyst is urea borate.

20. The polyurethane product of claim I produced by utilizing a urea and/or urea condensate and/or their salts as the urethane catalyst is urea salt of dimethyl methyl phosphonate.
